(19) United States
(12) Patent Application Publication
(10) Pub. No.: US 2014/0103088 A1
(43) Pub. Date: Apr. 17, 2014

(54) BREAKER AND BREAKING METHOD FOR LIQUID CRYSTAL PANEL

(71) Applicant: SHENZHEN CHINA STAR OPTOELECTRONICS TECHNOLOGY CO. LTD., Shenzhen, Guangdong (CN)

(72) Inventor: Haiwei Pan, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/812,865

(22) PCT Filed: Nov. 12, 2012
(86) PCT No.: PCT/CN12/84460

§ 371 Date: Jan. 29, 2013

(30) Foreign Application Priority Data
Oct. 16, 2012 (CN) 201210392572.X

(51) Int. Cl. C03B 33/033; G02F 1/13; G02F 1/1333

(52) U.S. Cl. CPC C03B 33/033; G02F 1/1333; G02F 1/1303
USPC 225/2; 225/106; 225/103

(57) ABSTRACT

A breaker for a liquid crystal panel, comprising an upper breaking plate and a lower breaking plate for clamping an edge-cutting area of the liquid crystal panel, wherein the breaker further comprises a first clamping mechanism for clamping two end portions of the upper breaking plate and two end portions of the lower breaking plate and a second clamping mechanism for clamping middle portions of the upper breaking plate and the lower breaking plate, and the second clamping mechanism comprises an upper clamping board, a lower clamping board parallel to the upper clamping board, and an assisted adjusting member for adjusting a distance between the upper clamping board and the lower clamping board.

### BACKGROUND

1. Technical Field

The present disclosure relates to liquid crystal displaying technologies, and particularly, to a breaker and a breaking method for a liquid crystal panel.

2. Description of Related Art

In optical alignment, a substrate is exposed to ultraviolet light to allow monomers in a liquid crystal panel to react when a voltage is applied onto the substrate, thereby realizing the alignment of liquid crystals. In order to apply the voltage onto the substrate, excessive material of a CF (color filter) substrate needs to be cut to reveal metal lines at two ends of a TFT (thin film transistor) substrate. That is, at first forming a cutting line on the CF substrate by a cutting machine and then separating the excessive material of the CF substrate which is located outside the cutting line by a breaker, thereby revealing a terminal area on two adjacent sides of the TFT substrate.

As shown in FIG. 1, a cross section of a present breaker is schematically shown. The breaker includes an upper breaking plate 101 and a lower breaking plate 102. The liquid crystal panel needs to be broken includes a TFT substrate 201 and a CF substrate 202. Liquid crystals are disposed between the TFT substrate 201 and the CF substrate 202 to form a displaying area 203. A sealant 204 surrounds the displaying area 203 to seal the liquid crystals in the displaying area 203 and connect the TFT substrate 201 and CF substrate 202. The breaking operation of the liquid crystal panel includes: forming a cutting line at a position on the CF substrate 202 located outside the sealant 204 by a cutting machine, pressing the upper breaking plate 101 against the TFT substrate 201 of the liquid crystal panel and pressing the lower breaking plate 102 against the CF substrate 202 of the liquid crystal panel, and moving the lower breaking plate 102 towards the upper breaking plate 101 (that is, moving along the direction shown by the arrow A) to break an outer end section of the CF substrate 202 along the cutting line, thereby separating the outer end section of the CF substrate 202 from the liquid crystal panel. The outer end section of the CF substrate 202 is then sucked to the lower breaking plate 101.

In the above breaker, since the upper breaking plate 101 and the lower breaking plate 102 are respectively clamped at two ends thereof, thus, a middle portion of the lower breaking plate may be curved when the lower breaking plate 102 moves towards the upper breaking plate 101, which causes the distance between two opposite end portions of the two breakers to be unequal to the distance between the middle portions of the two breakers, results in abnormal breaking operation, and thereby affecting the yield rate of the liquid crystal panel.

### SUMMARY

The present disclosure provides a breaking device for a liquid crystal panel for improving the yield rate of the breaking operation of the liquid crystal panel.

The breaker for a liquid crystal panel includes an upper breaking plate and a lower breaking plate for clamping an edge-cutting area of the liquid crystal panel, wherein the breaker further includes a first clamping mechanism for clamping two end portions of the upper breaking plate and two end portions of the lower breaking plate and a second clamping mechanism for clamping middle portions of the upper breaking plate and the lower breaking plate, and the second clamping mechanism includes an upper clamping board, a lower clamping board parallel to the upper clamping board, and an assisted adjusting member for adjusting a distance between the upper clamping board and the lower clamping board.

Preferably, the second clamping mechanism further includes a retractable device and controller for controlling the retractable device to move, the retractable device includes a fixing member and a movable member, and one of the fixing member and the movable member is connected to the upper clamping board and the other one is connected to the lower clamping board.

Preferably, the retractable device is a cylinder.

Preferably, the assisted adjusting member includes a clamping portion and a rotating portion arranged on the clamping portion, and the rotating portion passes through a top side of the clamping portion to cooperate with a bottom side of the clamping portion to clamp the upper clamping portion and the lower clamping portion.

Preferably, the first clamping mechanism includes a movable damper arranged on the corresponding end portion of the upper breaking plate and the corresponding end portion of the lower breaking plate; the movable damper includes a base, two motors respectively arranged on two ends of the base, and two fixing portions respectively connected to two output shafts of the motors; and the fixing portions are respectively connected to the corresponding end portions of the upper breaking plate and the lower breaking plate.

Preferably, the number of the second clamping mechanism is more than two, and the second clamping mechanism is spaced apart from each other.

The present disclosure further provides another breaker for a liquid crystal panel. The breaker includes an upper breaking plate and a lower breaking plate for clamping an edge-cutting area of the liquid crystal panel, wherein the breaker further includes a first clamping mechanism for clamping two end portions of the upper breaking plate and two end portions of the lower breaking plate, and a second clamping mechanism for clamping middle portions of the upper breaking plate and the lower breaking plate.

Preferably, the second clamping mechanism includes an upper clamping board and a lower clamping board parallel to the upper clamping board.

Preferably, the second clamping mechanism includes a retractable device and a controller for controlling the retractable device to move, the retractable device includes a fixing member and a movable member, and one of the fixing member and the movable member is connected to the upper clamping board and the other one is connected to the lower clamping board.

Preferably, the retractable device is a cylinder.

Preferably, the second mechanism further includes an assisted adjusting member for adjusting a distance between the upper clamping board and the lower clamping board.

Preferably, the assisted adjusting member includes a clamping portion and a rotating portion arranged on the clamping portion, and the rotating portion passes through a top side of the clamping portion to cooperate with a bottom side of the clamping portion to clamp the upper clamping portion and the lower clamping portion.

Preferably, the assisted adjusting member is a screw rod arranged on the fixing member, and the screw rod is engageable with a screw hole defined in the fixing member to adjust the distance between the upper clamping board and the lower clamping board.

Preferably, the distance between the upper clamping board and the lower clamping board is equal to the sum of a thickness of the upper breaking plate, a thickness of the lower breaking plate, and a thickness of the liquid crystal panel.

Preferably, the first clamping mechanism includes a movable damper arranged on the corresponding end portion of the upper breaking plate and the corresponding end portion of the lower breaking plate, the movable clamper includes a base, two motors arranged on two ends of the base, two fixing portions connected to output shafts of the motors, the fixing portions are respectively connected to the corresponding end portions of the upper breaking plate and the lower breaking plate.

Preferably, the number of the second clamping mechanism is more than two, and the second clamping mechanism is spaced apart from each other.

The present disclosure further yet provides a breaking method for a liquid crystal panel, including:

providing a breaker which includes an upper breaking plate, a lower breaking plate, a first clamping mechanism for clamping two end portions of the upper breaking plate and two end portions of the lower breaking plate, and a second clamping mechanism for clamping middle portions of the upper breaking plate and a lower breaking plate;

forming a cutting line on a CF substrate of the liquid crystal panel;

placing the liquid crystal panel forming the cutting line between the upper breaking plate and the lower breaking plate and clamping the liquid crystal panel at a position located outside the cutting line by the upper breaking plate and the lower breaking plate; and

adjusting the first clamping mechanism to break an outer end section of the CF substrate from the liquid crystal panel along the cutting line and adjusting the second clamping mechanism to clamp the middle portions of the upper breaking plate and the lower breaking plate.

In the present disclosure, with the second clamping mechanism clamping the middle portions of the upper breaking plate and the lower breaking plate, when the breaker is used for carrying out the breaking operation of the liquid crystal panel, the second clamping mechanism can be adjusted to bring the middle portions of the upper breaking plate and the lower breaking plate into close contact with the liquid crystal panel, which prevents the middle portions from being curved. In this way, an error of a distance between each portion of the upper breaking plate and the corresponding portion of the lower breaking plate can be kept less than 0.05 mm to normally break the liquid crystal panel and improve the yield rate of the liquid crystal panel.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of a present breaker for a liquid crystal panel;

FIG. 2 is a schematic view of a breaker for a liquid crystal panel in accordance with an embodiment of the present disclosure, wherein the breaker clamps an edge-cutting area of the liquid crystal panel;

FIG. 3 is a schematic view of a cross section of a second clamping mechanism of the breaker of FIG. 2 and the liquid crystal panel as a whole taken along the line B-B, wherein the breaker is at a state before breaking the liquid crystal panel;

FIG. 4 is similar to FIG. 3, wherein the breaker is at a state when breaking the liquid crystal panel;

FIG. 5 is a flow chart of a breaking method for a liquid crystal panel in accordance with an embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

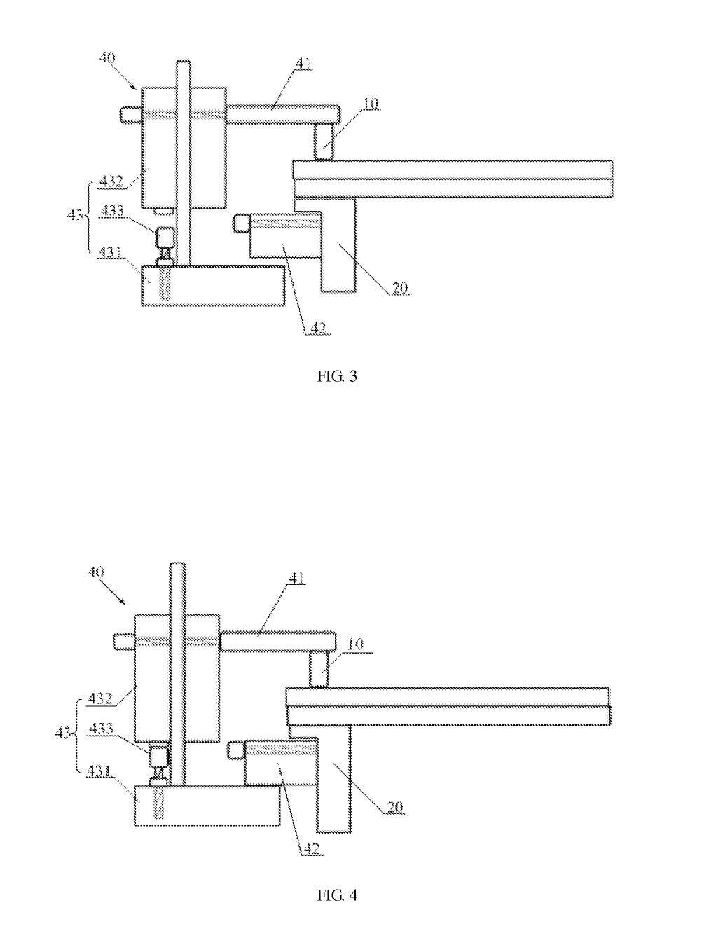

Referring to FIG. 2, a breaker for a liquid crystal panel in accordance with an embodiment of the present disclosure is schematically shown, wherein the breaker clamps an edge-cutting area of the liquid crystal panel. The breaker includes an upper breaking plate 10, a lower breaking plate 20, a first clamping mechanism 30 for clamping two end portions of the upper breaking plate 10 and two end portions of the lower breaking plate 20, and a second clamping mechanism 40 for clamping a middle portion of the upper breaking plate 10 and a middle portion of the lower breaking plate 20.

In the present disclosure, with the second clamping mechanism 40 clamping the middle portions of the upper breaking plate 10 and the lower breaking plate 20, when the breaker is used for carrying out the breaking operation of the liquid crystal panel, the second clamping mechanism 40 can be adjusted to bring the middle portions of the upper breaking plate 10 and the lower breaking plate 20 into close contact with the liquid crystal panel, which prevents the middle portions from being curved. In this way, an error of a distance between each portion of the upper breaking plate 10 and the corresponding portion of the lower breaking plate 20 can be kept less than 0.05 mm to normally break the liquid crystal panel and improve the yield rate of the liquid crystal panel.

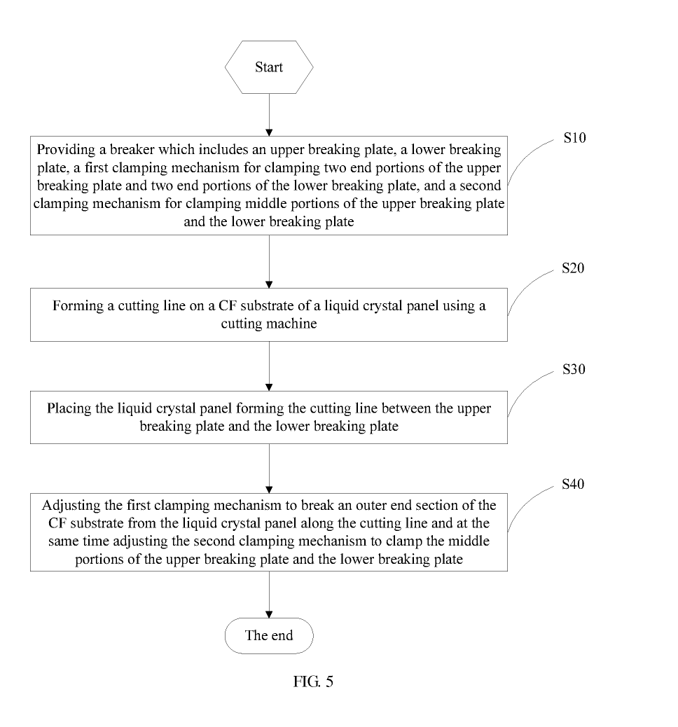

Furthermore, referring to FIGS. 3 and 4, in which FIG. 3 is a schematic view of the second clamping mechanism of the breaker and the liquid crystal panel, and FIG. 4 is schematic view showing the second clamping mechanism clamps the liquid crystal panel. The second clamping mechanism 40 includes an upper clamping board 41 and a lower clamping board 42 parallel to the upper clamping board 41. In an embodiment of the present disclosure, the distance between the upper clamping board 41 and the lower clamping board 42 is fixed. The distance can be slightly greater than or equal to the sum of a thickness of the upper breaking plate 10, a thickness of the lower breaking plate 20, and a thickness of the liquid crystal panel. The upper clamping board 41 is in close contact with the upper breaking plate 10 and the lower clamping board 42 is in close contact with the lower breaking plate 20. In another embodiment of the present disclosure, the distance between the upper clamping board 41 and the lower clamping board 42 is adjustable. For example, the second clamping mechanism 40 of the embodiment can further include a controller (not shown in the drawing) for controlling the retractable device 43 to move. The retractable device 43 includes a fixing member 431 and a movable member 432. The fixing member 431 is connected to the upper clamping board 41 and the movable member 432 is connected to the lower clamping board 42. It is noted that in other embodiments, the fixing member 431 can be connected to the lower clamping board 42 and the movable member 432 can be connected to the upper clamping board 41. With the controller capable of controlling the retractable device 43 to move, the distance between the upper clamping board 41 and the lower clamping board 42 can be adjusted. Preferably, the retractable device is a cylinder. It is noted that the retractable device can be any other device having the function described above.

Furthermore, the second clamping mechanism 40 further includes an assisted adjusting member 433 for adjusting the distance between the upper clamping board 41 and the lower clamping board 42. After the distance between the upper clamping board 41 and the lower clamping board 42 are determined by the controller, the distance between the upper clamping board 41 and the lower clamping board 42 can be slightly adjusted using the assisted adjusting member 433 to bring the upper clamping board 41 into a closer contact with the upper breaking plate 10 and to bring the lower clamping board 42 into a closer contact with the lower breaking plate 20.

Furthermore, in an embodiment, the assisted adjusting member 433 is a screw rod arranged on the fixing member 431 which is engageable with a screw hole defined in the fixing member 431. The distance between the fixing member 431 and the movable member 432 can be adjusted by rotating a nut of the screw rod, thereby adjusting the distance between the upper clamping board 41 and the lower clamping board 42. In another embodiment, the assisted adjusting member 433 can include a “[”-shaped clamping portion and a rotating portion arranged on the clamping portion. The rotating portion passes through a top side of the clamping portion to cooperate with a bottom side of the clamping portion to clamp the upper clamping portion 41 and the lower clamping portion 42. The rotating portion can be rotated to adjust the distance between the rotating portion and the bottom side of the clamping portion, thereby adjusting the distance between the upper clamping portion 41 and the lower clamping portion 42.

Furthermore, the first clamping mechanism 30 includes two movable clampers 30a, 30b respectively connected to the corresponding end portion of the upper breaking plate 10 and the corresponding end portion of the lower breaking plate 20. Take the movable clamper 30a as an example, the movable clamper 30a includes a base 31, two motors 32 disposed on two ends of the base 31, and two fixing portions 33 respectively connected to output shafts of the two motors 32. The fixing portions 33 are respectively connected to the corresponding end portion of the upper breaking plate 10 and the corresponding end portion of the lower breaking plate 20.

Furthermore, the number of the second clamping mechanism 40 is more than two and the second clamping mechanisms 40 are spaced apart from each other. Since the length of the upper breaking plate 10 or the lower breaking plate 20 is respectively relatively great, for example, the length may reach 2.9 m, thus, by disposing the spaced-apart second clamping mechanisms 40 on the middle portions of the upper breaking plate 10 and the lower breaking plate 20, the upper breaking plate 10 and the lower breaking plate 20 can be clamped together. In the embodiment, each breaking plate can be respectively divided into three equal parts of which middle part is the middle portion of the upper breaking plate 10 or the lower breaking plate 20.

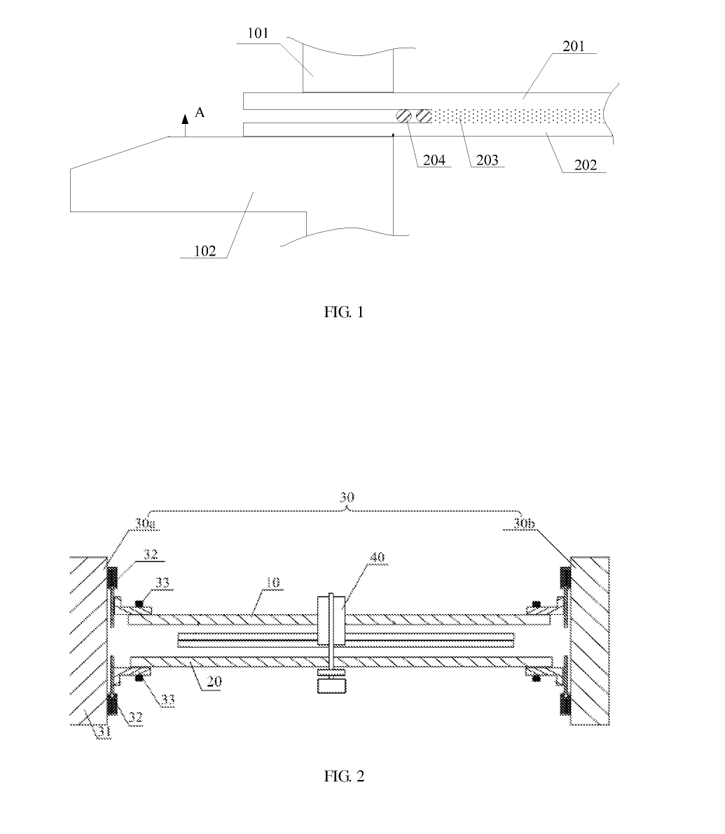

As shown in FIG. 1, when using the breaker to carry out the breaking operation of the liquid crystal panel, the liquid crystal panel is clamped between the upper breaking plate 10 and the lower breaking plate 20. The first clamping mechanism 30 is then adjusted to drive the end portions of the lower breaking plate 20 to move towards the upper breaking plate 10 to break an outer end section of a CF substrate along a cutting line. Meanwhile, the second clamping mechanism 40 is adjusted to clamp the middle portions of the upper breaking plate 10 and the lower breaking plate 20, which allows the error of the distance between the upper breaking plate 10 and the lower breaking plate 20 to be kept less than 0.05 mm when the end portions of the lower breaking plate 20 move towards the upper breaking plate 10, thereby improving the yield rate of the liquid crystal panel.

Referring to FIG. 5, which is a flow chart of a breaking method for the liquid crystal panel in accordance with an embodiment of the present disclosure. The breaking method includes the following steps:

Step S10, providing a breaker which includes an upper breaking plate, a lower breaking plate, a first clamping mechanism for clamping two end portions of the upper breaking plate and two end portions of the lower breaking plate, and a second clamping mechanism for clamping middle portions of the upper breaking plate and the lower breaking plate.

The breaker of the embodiment is similar to that of the breaker of the above embodiment, which is not given in detail again.

Step S20, forming a cutting line on a CF substrate of a liquid crystal panel using a cutting machine.

Step S30, placing the liquid crystal panel forming the cutting line between the upper breaking plate and the lower breaking plate.

Step S40, adjusting the first clamping mechanism to break an outer end section of the CF substrate from the liquid crystal panel along the cutting line and at the same time adjusting the second clamping mechanism to clamp the middle portions of the upper breaking plate and the lower breaking plate.

The cutting line is at first formed on the outer end section of the CF substrate of the liquid crystal panel located outside the displaying area of the liquid crystal panel. The liquid crystal panel forming the cutting line is then placed between the upper breaking plate 10 and the lower breaking plate 20. At this time, a TFT substrate of the liquid crystal panel is in close contact with the upper breaking plate and the CF substrate of the liquid crystal panel is in close contact with the lower breaking plate 20. The first clamping mechanism 20 is adjusted to drive the end portions of the lower breaking plate 20 to move towards the upper breaking plate 10, thereby breaking the outer end section of the CF substrate from the liquid crystal panel. Meanwhile, the second clamping mechanism 40 is adjusted to bring the upper breaking plate 10 and the lower breaking plate 20 into close contact with the liquid crystal panel.

In the present disclosure, with the second clamping mechanism 40 clamping the middle portions of the upper breaking plate 10 and the lower breaking plate 20, when the breaker is used for carrying out the breaking operation of the liquid crystal panel, the second clamping mechanism 40 can be adjusted to bring the middle portions of the upper breaking plate 10 and the lower breaking plate 20 into close contact with the liquid crystal panel, which prevents the middle portions from being curved. In this way, an error of the distance between each portion of the upper breaking plate 10 and the corresponding portion of the lower breaking plate 20 can be kept less than 0.05 mm to normally break the liquid crystal panel and improve the yield rate of the liquid crystal panel.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

1. A breaker for a liquid crystal panel, comprising an upper breaking plate and a lower breaking plate for clamping an edge-cutting area of the liquid crystal panel, wherein the breaker further comprises a first clamping mechanism for clamping two end portions of the upper breaking plate and two end portions of the lower breaking plate and a second clamping mechanism for clamping middle portions of the upper breaking plate and the lower breaking plate, and the second clamping mechanism comprises an upper clamping board, a lower clamping board parallel to the upper clamping board, and an assisted adjusting member for adjusting a distance between the upper clamping board and the lower clamping board.

2. The breaker for a liquid crystal panel as claimed in claim 1, wherein the second clamping mechanism further comprises a retractable device and controller for controlling the retractable device to move, the retractable device comprises a fixing member and a movable member, and one of the fixing member and the movable member is connected to the upper clamping board and the other one is connected to the lower clamping board.

3. The breaker for a liquid crystal panel as claimed in claim 2, wherein the retractable device is a cylinder.

4. The breaker for a liquid crystal panel as claimed in claim 1, wherein the assisted adjusting member comprises a clamping portion and a rotating portion arranged on the clamping portion, and the rotating portion passes through a top side of the clamping portion to cooperate with a bottom side of the clamping portion to clamp the upper clamping board and the lower clamping board.

5. The breaker for a liquid crystal panel as claimed in claim 1, wherein the first clamping mechanism comprises a movable clamper arranged on the corresponding end portion of the upper breaking plate and the corresponding end portion of the lower breaking plate; the movable damper comprises a base, two motors respectively arranged on two ends of the base, and two fixing portions respectively connected to two output shafts of the motors; and the fixing portions are respectively connected to the corresponding end portions of the upper breaking plate and the lower breaking plate.

6. The breaker for a liquid crystal panel as claimed in claim 1, wherein the number of the second clamping mechanism is more than two, and the second clamping mechanism is spaced apart from each other.

7. A breaker for a liquid crystal panel, comprising an upper breaking plate and a lower breaking plate for clamping an edge-cutting area of the liquid crystal panel, wherein the breaker further comprises a first clamping mechanism for clamping two end portions of the upper breaking plate and two end portions of the lower breaking plate, and a second clamping mechanism for clamping middle portions of the upper breaking plate and the lower breaking plate.

8. The breaker for a liquid crystal panel as claimed in claim 7, wherein the second clamping mechanism comprises an upper clamping board and a lower clamping board parallel to the upper clamping board.

9. The breaker for a liquid crystal panel as claimed in claim 8, wherein the second clamping mechanism comprises a retractable device and a controller for controlling the retractable device to move, the retractable device comprises a fixing member and a movable member, and one of the fixing member and the movable member is connected to the upper clamping board and the other one is connected to the lower clamping board.

10. The breaker for a liquid crystal panel as claimed in claim 9, wherein the retractable device is a cylinder.

11. The breaker for a liquid crystal panel as claimed in claim 9, wherein the second mechanism further comprises an assisted adjusting member for adjusting a distance between the upper clamping board and the lower clamping board.

12. The breaker for a liquid crystal panel as claimed in claim 11, wherein the assisted adjusting member comprises a clamping portion and a rotating portion arranged on the clamping portion, and the rotating portion passes through a top side of the clamping portion to cooperate with a bottom side of the clamping portion to clamp the upper clamping board and the lower clamping board.

13. The breaker for a liquid crystal panel as claimed in claim 11, wherein the assisted adjusting member is a screw rod arranged on the fixing member, and the screw rod is engageable with a screw hole defined in the fixing member to adjust the distance between the upper clamping board and the lower clamping board.

14. The breaker for a liquid crystal panel as claimed in claim 8, wherein the distance between the upper clamping board and the lower clamping board is equal to the sum of a thickness of the upper breaking plate, a thickness of the lower breaking plate, and a thickness of the liquid crystal panel.

15. The breaker for a liquid crystal panel as claimed in claim 7, wherein the first clamping mechanism comprises a movable clamper arranged on the corresponding end portion of the upper breaking plate and the corresponding end portion of the lower breaking plate, the movable clamper comprises a base, two motors arranged on two ends of the base, two fixing portions connected to output shafts of the motors, the fixing portions are respectively connected to the corresponding end portions of the upper breaking plate and the lower breaking plate.

16. The breaker for a liquid crystal panel as claimed in claim 7, wherein the number of the second clamping mechanism is more than two, and the second clamping mechanism is spaced apart from each other.

17. A breaking method for a liquid crystal panel, comprises:
providing a breaker which comprises an upper breaking plate, a lower breaking plate, a first clamping mechanism for clamping two end portions of the upper breaking plate and two end portions of the lower breaking plate, and a second clamping mechanism for clamping middle portions of the upper breaking plate and a lower breaking plate;
forming a cutting line on a CF substrate of the liquid crystal panel;
placing the liquid crystal panel forming the cutting line between the upper breaking plate and the lower breaking plate and clamping the liquid crystal panel at a position located outside the cutting line by the upper breaking plate and the lower breaking plate; and
adjusting the first clamping mechanism to break an outer end section of the CF substrate from the liquid crystal panel along the cutting line and adjusting the second clamping mechanism to clamp the middle portions of the upper breaking plate and the lower breaking plate.
